(19) United States
(12) Patent Application Publication
(10) Pub. No.: US 2007/0084423 A1
(43) Pub. Date: Apr. 19, 2007

(54) HYDROGEN PEROXIDE INJECTION ENGINE AND COMBUSTION FUEL SUPPLAMENTATION

(75) Inventor: Kelvin LeBeaux, Jacksonville, FL (US)

Correspondence Address: KELVIN LEBEAUX, 11261 BROCKTON PL., JACKSONVILLE, FL, 32257, US

(73) Assignee: Kelvin LeBeaux, Jacksonville, FL (US)

(21) Appl. No.: 11/163,381

(22) Filed: Oct. 17, 2005

(51) Int. Cl. F02B 43/00

(52) U.S. Cl. 123/1 A

(57) ABSTRACT

This invention is a electronic and mechanical system that comprises of several sub-systems which carries out a new method of using different concentrations of self-propelled hydrogen peroxide-based solutions for direct propulsion in engines designed to use only gas pressure as energy or the system may act as a fuel supplement in existing combustion engines, by manipulating existing oil-based fuel engine's sensor signals to give the system the ability to make the engine run much leaner conditions, or inject less fuel while simultaneously injecting varying concentrations of hydrogen peroxide/water/alcohol solution, consequently saving gas by lowering intake temperatures to reduce the occurrence of knock and exploiting this reduction in temperature by reducing the amount of fuel needed by the engine at all engine running ranges. Standard mechanical pump fluid injection is not new and neither is pressurized propellant system designs, but this system becomes vary abstract when analyzing its method of using an essential, non-cryogenic, safe, self-propelled liquid monopropellant, in hydrogen peroxide; one of the best natural heat absorbers, in water, and releasing the potential of the hydrogen peroxide catalytic decomposition affect in a method of controlled decomposition pressurization within a feed-back loop while adding oxygen to combustion, and the water as a supplement to reduce excess heat in an engine. The system uses a self-pressurizing, concentration-monitoring, high purity stainless steel or aluminum peroxide storage tank which when used in conjunction with a metallic screen catalytic feed-back loop provides pressurized hydrogen peroxide-based solution to the injection solenoid, and when the solenoid is open allows pressurized water and oxygen to the injectors and into an engine. This system allows for a non-cryogenic, safe, non-polluting fuel source for many applications which will only produce water and oxygen, when used as hydrogen peroxide/water for a purely pressure engine, or significantly reduces fuel consumption in piggy-backed hybrid configurations using varying concentrations of hydrogen peroxide, water, alcohol and other fuels for use in the supplementation of combustion in existing fossil fuels engines. Retrofitting this system into existing gasoline, diesel and other fossil fuel engines will be very low cost, since it can intercept most of the factory sensor signals and send manipulated signals to the existing factory ECM inputs to allow the system to change the amount of injected standard fuel and adjust for the much lower intake air temperatures and extra oxygen provided by the decomposed hydrogen peroxide solution injection, while significantly reducing factory fuel system consumption the entire time that the system is actually injecting solution. No system developed has brought the benefits of all of these elements together in this manner. The level of sophistication and methods at which this system regulates itself, manipulates external fuel systems, decomposes hydrogen peroxide solutions into water and oxygen for self-pressurizing the system, and brings these elements together in a synergistic alliance with each other, all while injecting a precise amount of pressurized water and oxygen supplement to combustion events in an engine, are the truly abstract concepts behind this system. Combined with the system's easy adaptability and upgradeability should give a complete insight into the truly abstract design and methodology of this system.

### BACKGROUND OF INVENTION

1. Field of Invention

The present invention relates to the modern combustion engine, internal and external, and more particularly to a system that can use safe, low-concentration, self-propelled hydrogen peroxide solutions to inject varying amounts of pressurized water, oxygen and alcohol fuels directly into an intake manifold or combustion chamber of a combustion engine, by the means of catalytically decomposed hydrogen peroxide solution, to reduce the amount of fuel needed by an existing engine or a more robust version of the same system that can use high-concentration hydrogen peroxide and water solution to inject very highly pressurized water and oxygen into an engine designed to use gas pressure for energy or mechanism to directly drive a pressure driven turbine or piston type motor. The system can be adapted to run many combinations of hydrogen peroxide, water and fuel mixture in many engine types, like automotive, aerospace, and many other fields that currently utilizes combustion for propulsion. It also relates to the problem of fuel efficiency in today's modern combustion engine, more directly a system that uses precise amounts of safe, low-concentration hydrogen peroxide solution to inject pressurized water, oxygen and alcohol fuels into a combustion engine while also manipulating factory vehicle's Engine Control Module (ECM), to cause the engine to run less fuel without damaging standard factory original equipment engine components.

2. Background of Invention

The invention was designed among times of growing concern about pollution, fuel efficiency, and natural resource stabilization. It is well known that prior art combustion engines are not very efficient at transferring energy, due to the transfer of heat in metal components, loss caused by friction in its metal parts, and an the wasteful incomplete burning of gasoline, diesel, JP-5, or other fuels in the hot compressed combustion chambers. Due to the high inherent heat transfer characteristics of the materials that make up a modern combustion engines, fuel efficiency is sacrificed to produce an effective amount of power, while sacrificing wasted extra fuel to absorb enough heat to reduce the occurrence of knock or pre-detonation caused by excessive heat, mostly in mid to high load driving situations also causing higher polluting emissions.

It is also well known that injecting water, alcohol, or other heat absorbing liquids into and engine will reduce the occurrence of knock by reducing combustion chamber temperatures enough to keep hot metal parts cool enough to reduce the possibility of pre-detonation. For instance U.S. Pat. No. 4,351,289, assigned to V. A. Renda, describes a system which injects water into and engine when a certain set engine torque is met and is controlled by a simple manifold vacuum switch. The switch controls an electrical water pump, which actually initiates injection through a nozzle.

Another great system, U.S. Pat. No. 5,148,776, assigned to M. J. Connor, describes a similar way of injecting water and fuel into an internal combustion engine. This system uses throttle position sensor to determine the amount of water to inject and other sensors to determine the timing of the injections.

An even earlier system, U.S. Pat. No. 4,096,829, assigned to G. Spears, was designed to inject water into carbureted engines. This system used an engine RPM sensor to determine when to inject water and was also controlled by a similar switch and electric pump setup.

There is also a system, U.S. Pat. No. 577,771,847, assigned to A. W. Duva, that describes using an oxidant, such as hydrogen peroxide which mixes with fuel through a valve which mixes, emulsifies, and injects the emulsified fuel into an engine.

All of these systems use similar methods to essentially lower engine temperatures and allow an engine to run safer in high load or low efficiency situations. None of these systems actually address using the self-pressurizing energetic decomposition of hydrogen peroxide or the ability to manipulate current injection systems to the degree, or with the precision effective enough to cause the engine to run as extremely lean and safely as this system will allow by manipulating multiple variables simultaneously through complex computations. The ideal situation of a cooler combustion has been realized by many, but no system has taken full advantage of the heat absorbing power of water to allow for the fractional amounts of fuel that could be used with the use of very small proportional amounts of the super heat absorbing agent, water, to reduce the amount of fuel actually used by the engine at all running ranges. All of these systems also use the very slow responsive method of using an electrical pump on a switch to provide injection. And in most cases unreliable analog switch calculations are used to determine the amount and/or occurrence of injection. This system makes better use of the stored potential in water, hydrogen peroxide, and alcohol, but had similar beginnings as prior art devices.

The system was originally designed to use a mechanical pump to spray water into existing combustion engines to reduce intake air temperatures, which reduces the occurrence of knock or pre-detonation; however, with further testing, it was shown that electric pumps, relays, and analog sensor computations are far too inaccurate, unreliable and far too slow to respond to allow for much more then a safety system to keep temperatures down at some set point determined usually by slightly deteriorated analog voltages. The system began to be, when it was determined that the catalytic decomposition of hydrogen peroxide solutions, could be used as a means to self-pressurize an injection system and to propel the solution into the engine. It was also determined that using hydrogen peroxide would have the added benefit of adding an oxidant into an engine, which can be compared to today's current use of Nitrous Oxide to carry more oxygen to combustion along with supplemented fuel for a great increase in power as compressed oxygen supplements combustion which can be used in conjunction with the fuel and peroxide injection nozzle detailed further in FIG. 7. The system has improved efficiency over existing prior arts devices designed to inject liquid into a combustion engine intake, since no electricity is needed to drive pumps. The Hydrogen Peroxide injection system also shows the promise of greater reliability with the reduction in parts needed and the added affect of the extra oxygen in the decomposed products allowed the system to be able to increase efficiency easier then previous prototypes and allows the system to be able to increase power output of the engine with highly reduced increases in the amount of fuel provided by the pre-existing gasoline injection system of the engine in conjunction with an injector nozzle detailed further in FIG. 7. It was also shown that if injected with precise timing, the extremely energetic catalytic decomposition of a highly concentration hydrogen peroxide solution could be used as the sole reaction to make mechanical force within purely pressure driven engine and a more simple nozzle design like the one in FIG. 6 could be used.

As the manipulation of engine running parameters became easier through microprocessor subsystem controlling and monitoring, the benefits of such hydrogen peroxide solution injections, which breaks down into water and oxygen then absorbs much more heat then gasoline, could be used to reduce intake manifold temperatures which reduces the occurrence of knock, or pre-detonation caused by high intake temperatures, high cylinder compression, compression from forced air induction systems, and excessive fuel vaporization. The system began to exploit this reduction in the occurrence of knock by reducing the excessive amounts of fuel injected in medium to high load driving situations, which are pre-programmed as memory maps into the vehicles Engine Control Module to match the expected running parameters of the Engine, and is mapped to inject more fuel then actually necessary to produced efficient power in current internal combustion engines to absorb heat created by the load of acceleration and is reflected in more un-burnt fuel or pollution exiting the engine.

The system is designed to intercept and change the engine sensor signals and voltages that enter the existing Engine Control Module so that it can control the amount of gasoline that is injected by the pre-existing system at any time. Each sub subsystem was created from first an embedded microprocessor with its unique interrupt command to send and receive data on the system's communication bus. Then each subsystem is assembled with other supporting devices that may be needed to carry out its function. The microprocessor-based subsystems were used to control and monitor every subsystem that the Hydrogen Peroxide Injection system includes. Assembly code programs were used to control the microprocessors and copyrights for these programs have been filed, and will be used in conjunction with this system. The invention follows and utilizes previously copyrighted microprocessor code registered to Kelvin P. LeBeaux 2005, entitled “0-30 PSI BOOST ANALOG TO 2×7 SEGMENT DISPLAY” and “MAF CONVERTER.” The current program entitled “0-30 PSI BOOST ANALOG TO 2×7 SEGMENT DISPLAY” allows low-cost embedded microprocessors, with minimal supporting components, to be able to convert analog sensor data from 0-5V or variable resistance sensors into recognizable control module data and transmit this data to the control module via the system's data bus or outputs this data to a double digit 7 segment digital display. A version of this program will be written to allow a completely separate display module, with its own interrupt command, to create a graphical representation of any piggy-backed spliced engine sensor or any subsystem sensor module and display composite RF signal graphics and overlap the generated graphical signal over existing interlaced video signals entering an existing RCA composite video monitor in direct viewing sensor gauge over RF configuration or in Heads Up Display configuration with inverted graphics over inverted video synchronization. The current program entitled “MAF CONVERTER” allows low-cost embedded microprocessors with minimal supporting components to be able to convert a wide range of high-speed digital sensor data into recognizable control module data and transmits this data to the control module via the system's data bus and inputs digital Mass Air Flow (MAF) sensor data and increases or decreases the signals frequency depending on commands from the data bus then outputs recognizable high-speed Mass Airflow Sensor (MAS) data to the system data bus. Variations of these programs and others that are currently being written will allow each low-cost, highly reliable microprocessors to act as a control for its own subsystem as they communicate with each other and the control modules via a system data bus that can consist of a conducting wire serial or parallel communication port setup, RF transceivers in serial or multiplexed parallel setups, or fiber optic transceivers in serial or multiplexed parallel setups. The benefits between these data bus setups slightly change the accuracy of the system. A conducting wire data bus system is low-cost, but least reliable, especially when long lengths of wire is needed between subsystems, which will drop some of the signal voltage as it passes through the wire; a RF transceiver data bus system is mid-cost, but is very easily upgraded and integrated which is a benefit and a down-side since the easy integration allows less security and more interference from other signals; a fiber optic cable data bus system has the highest cost, but also the highest security, since the subsystem components can be contained behind EMP and ESD shielding for protection in some of the harshest electronic environments and a fiber optic transceiver bus has the fastest response and best data integrity when compared to any other type of communication bus. The system was design to utilize generic protocols which can be produced as microprocessor sub commands allowing communications with each other using many bus types and be easily adapted to new protocols that may follow.

As software and sensors change, the general operation of the system remains, and because of the low cost, modular design of the current hydrogen peroxide solution injection system, the system can remain highly reliable, easy to upgraded, and offer a very highly sophisticated level of adaptability, and it takes advantage of using supporting comparator circuits configured to act as a neural network and send flagged priority commands, such as the occurrence of knock, high engine temperature, emergency tank pressure levels and other pressure monitoring subsystems signals, which is detailed further in FIG. 2. The system also utilizes “Fuzzy” logic type progressive calculus derivative based programming embedded described in FIG. 3, FIG. 4, and FIG. 5, along with several of the most important, over-redundant, and safety sub-system microprocessors and mechanisms makes this system very flexible and reliable. As a result of the modular design of the system and all of its individual programs it can easily be re-arranged with new subsystems and as microprocessor design becomes more advanced and supporting components become more advanced, the system and its bus will remain and the only parts that will be required to change are the new individual subsystem modules being added and a global bus software upload directly the control module or via commands to the communication bus that assigns the new subsystem module's interrupt command and updates operating parameters to all other modules to react to the change of the system. These are very minimal changes to be able to adapt, and only takes the subsystems a matter of microseconds to update their individual instructions on how to adapt to the new module. As other new technology in many fields of engineering and science may arrive, this system is designed to be highly modular and easily adaptable to new hardware, so users will always have the ability to update and adapt.

### SUMMARY OF THE INVENTION

It is an object of this invention to provide many varieties of combustion engines, internal and external, with a supplemental supply of varying percentages of hydrogen peroxide/water/alcohol solutions to reduce engine operating temperatures and lower the knock (pre-detonation of excessive fuel vapors) range of an engine, consequently allowing the engine to be run safely in a leaner or less fuel rich environment. It is another object of this invention to provide an injection system for a pressure driven engine that will rely completely on the accelerated highly energetic decomposition of high concentration hydrogen peroxide/water solution to convert the stored chemical potential energy of the hydrogen peroxide solution into the mechanical energy for the motion of a purely compression engine.

It is another object of this invention to reduce the amount of fossil fuels used in combustion engines by manipulating the air flow signal and/or oxygen sensor voltage that enters the existing factory Engine Control Module (ECM), by tapping of off the existing wiring harness, to allow the system to reduce the amount of fossil fuel injected into the engine.

It is another object of this invention to monitor and record the knock signal, throttle position sensor, crank angle sensor and manifold pressure signal data of the existing engine by tapping off of the existing engine's wiring harness from the engine to the ECM to allow the system to calculate the precise amount of hydrogen peroxide-based solution injected for the current running conditions, available concentration, and pressure of hydrogen peroxide/water/alcohol solution in the pressurize storage tank, which is specifically prepared to store hydrogen peroxide.

It is another object of the present invention to stay highly compact and operated between each part of the system through network type communications to allow the system to be very easily repaired and maintained as well as allowing for very easy retrofitting into existing applications.

### BRIEF DESCRIPTION OF DRAWINGS

A much more complete view of the current invention can be appreciated when contemplated in conjunction with the technical drawings that fulfill the complete embodiment of the invention.

FIG. 1 gives overall representation of the mechanical features of the system as used with combustion engines.

FIG. 2 is a diagram that more clearly defines the structure and operation of the control module operation in combustion engines.

FIG. 3 shows a “Fuzzy” logic graph that outlines how the control module uses oxygen sensor data in its calculation of hydrogen peroxide flow rate changes.

FIG. 4 shows a “Fuzzy” logic graph that outlines how the control module uses similar patterns with airflow, engine speed, and throttle position sensor data in its calculation of hydrogen peroxide flow rate changes.

FIG. 5 shows a “Fuzzy” logic graph that outlines how the control module uses similar patterns in hydrogen peroxide concentration and peroxide tank pressure data in its calculation of hydrogen peroxide flow rate changes.

FIG. 6 shows an open view of an injector designed to inject only hydrogen peroxide solution.

FIG. 7 shows an open view of an injector that is designed to mix external fuel with decomposed solution components.

FIG. 8 shows how the system can be adapted to drive turbine like gas pressure engines with pairs of injections.

### DESCRIPTION OF PREFERRED EMBODIMENT

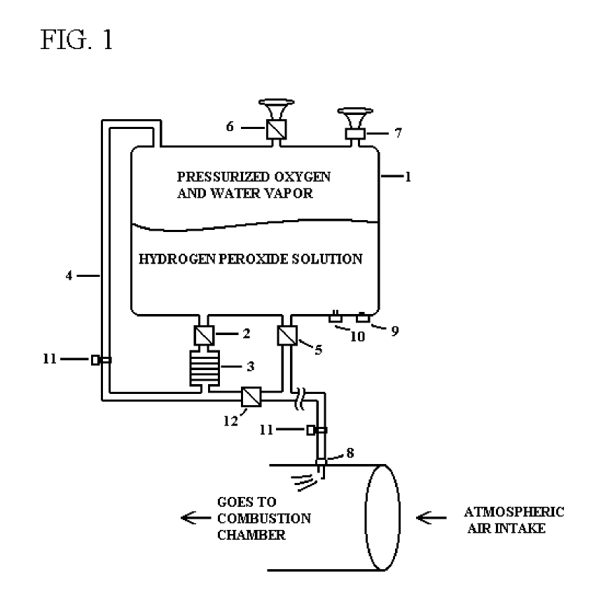

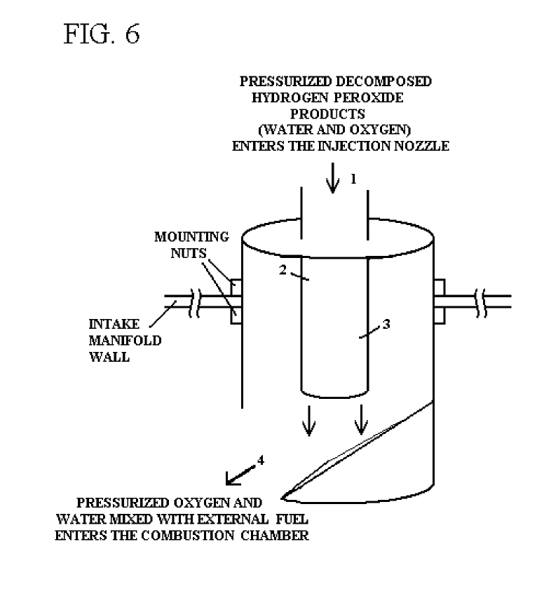

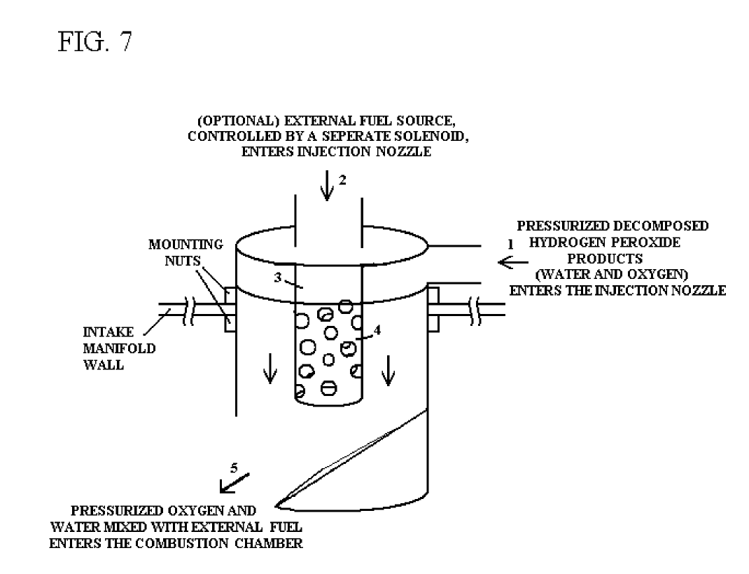

In FIG. 1 there is shown the general focus of this invention which is the self-pressurized monopropellant design of the hydrogen peroxide tank, the modularity of the system, and the easily adaptable piggy-back design of the overall system. The tank 1 is designed around a series of microprocessor control solenoids. The feed-back solenoid 2 is responsible for pressuring the tank. When this solenoid is open it allows hydrogen peroxide solution, because of the acceleration due to gravity, to pass through to the catalyst pack 3. The catalyst pack 3 uses metal screens made from steel, low purity aluminum, manganese oxide, platinum, or many numerous metals known to act as a catalyst to the natural decomposition reaction of hydrogen peroxide. It is important to note how the high pressure products side of the hydrogen peroxide heat and catalyst reaction gives a high velocity gas and endothermic or cooling reaction H₂O₂ (liquid)+H₂O (liquid)+heat+catalyst→H₂O (liquid)+H₂O (gas)+O₂ (gas) is introduced into the top of the hydrogen peroxide storage tank, which acts to pressurize the tanks when injection is needed. After the hydrogen peroxide solution is decomposed into compressed oxygen and water it returns to the tank via the feed-back loop 4. The feed-back loop 4 is designed to start at the bottom of the tank, so that it will be able to use acceleration due to gravity to draw the solution into the catalyst pack, then allows decomposed water to remain in the bottom of the loop to act as a boundary the catalyst pack 3 and the tank 1. Then pressurized oxygen and water gas exits into the top of the tank 1, so that the fairly cool compressed gas will not have to pass through solution to pressurize the tank, which would cause the concentration of the solution to be reduced faster. After the tank 1 becomes pressurized by the previously mentioned feed-back process, the system is ready to inject solution. When injections are required, signals are sent to the injector solenoids 5 and the injection concentration control solenoid module 12. The injection solenoid module 5 opens and releases highly pressurized hydrogen peroxide solution, directly from the tank into the rest of the solution line which ends at the injector nozzle 8; and the injection concentration control module 12 opens simultaneously with the feed-back control solenoid module 2 to dilute the injection solution with water which is the output from the catalyst, when solution concentrations are to high. Strategically place pressure sensors 11 are place along the fluid lines at different point to determine if leaks occur, and similarly design pressure sensor modules can be used to determine pressures at different points in the existing engine system, like manifold pressure, barometric pressure, etc. A big enough leak determined by the difference in sensor values will shut down the system and return the engine to normal running parameters until the condition is fixed. The injector nozzles 8, which are described further in FIG. 6 and FIG. 7, depending on materials used can be designed to decompose the remaining hydrogen peroxide in the solution into its components before the solution enters the intake or designed to preserve the hydrogen peroxide concentration into the intake. There are times that the hydrogen peroxide storage tank 1 may become over-pressurized. The pressure relief solenoid module 6 is designed to electronically open when an over-pressure conditions happens within the tank 1, which can happen from the natural decomposition of hydrogen peroxide solution with the passage of time. Pressure build-up within a tank can be very dangerous, and if the pressure passes the safe operating range of the tank 1 it can turn the tank 1 into a dangerous component. To back up the pressure relief solenoid module 6, an emergency mechanical pressure relief valve 7 is added to the top of the tank 1, so that if the pressure relief solenoid module 6 fails for some reason, the system will not become dangerous. The amount of solution remaining is measured with a fluid level sensor 9. This fluid level sensor 9 is crucial because, when no solution is left, because the engine must return to injecting the stock amount of fuel to avoid knock, while the system is empty and cannot deliver solution. Without the heat absorbing solution supplementation the engine will begin to knock if the system doesn't correct the engine to original parameters when not injecting solution, so the system must be warned prior to losing solution so that knock will not occur. The concentration of hydrogen peroxide within the solution is measured with the use of an infra scanning sensor 10. The infra scanning sensor 10 will continuously scan between the wavelengths from 280 nm to 320 nm, in a similar method that is described by Dr. Todd A. Cerni in his U.S. Pat. No. 6,709,311. However the sensor mechanism is different in that is does not remove solution from the loop to measure; instead it inserts a wide band fiber optic source and a grating fiber that can selectively tune narrow frequencies. The concentration levels will be calculated with similar calculations explained in U.S. Pat. No. 6,709,311 to T. A. Cerni, but with an infrared grating fiber that scans the relevant frequencies for determining hydrogen peroxide solutions concentrations which is changed into useable data and transmitted to the control computer along with other data from other sensor modules used to determine the amount of hydrogen peroxide/water solution to inject.

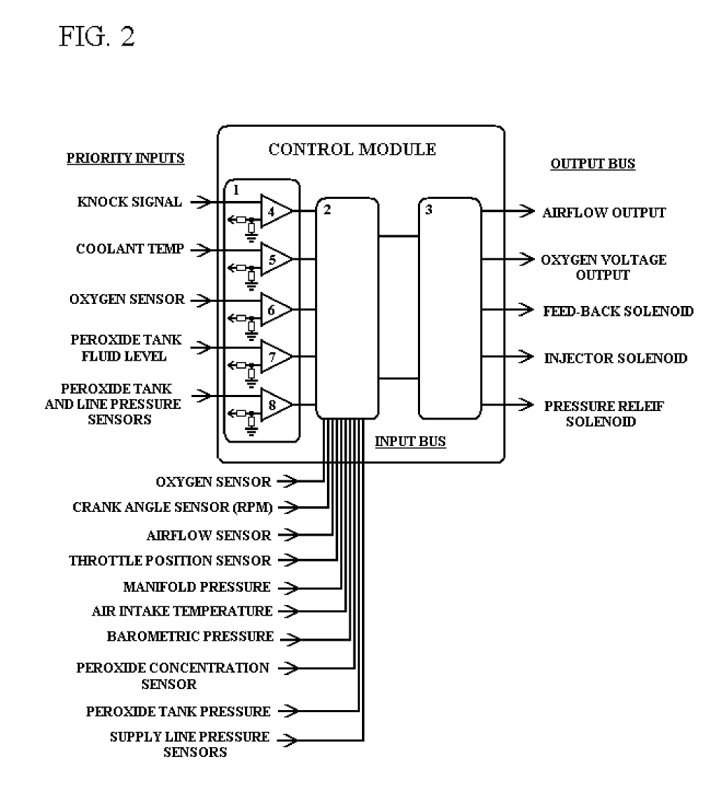

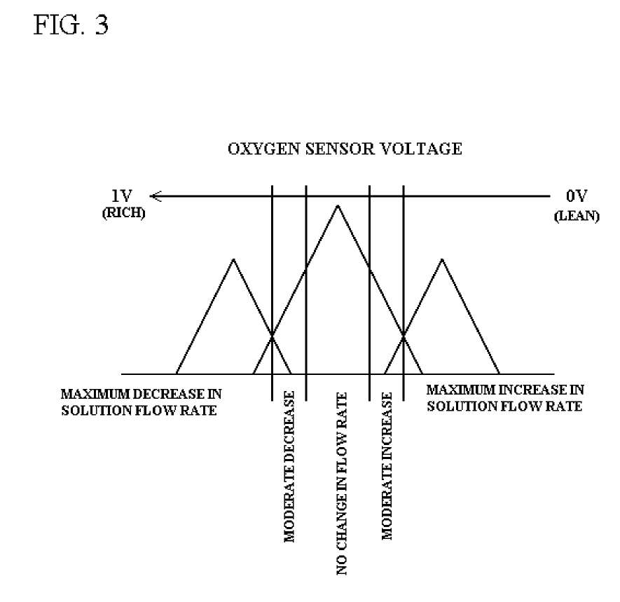

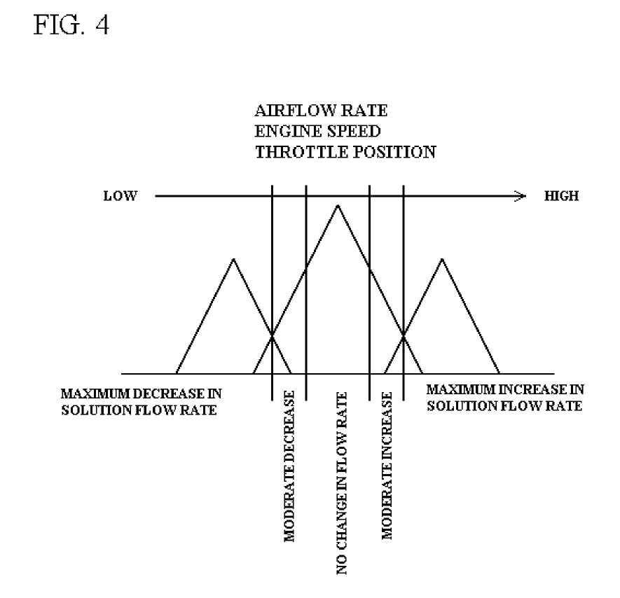

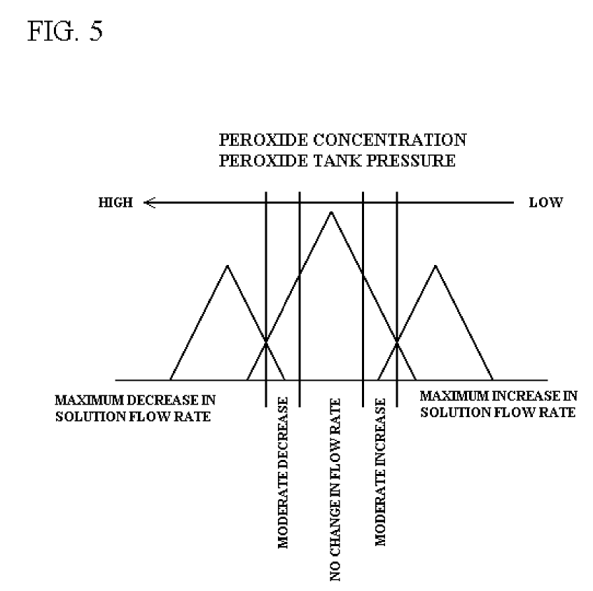

In FIG. 2 there is shown a diagram which shows a representation of the inner structures and connections of the control module. First are the priority inputs, which pass through a neural network filtering circuit 1. This neural network 1 is precisely calibrated to react when certain conditions are met and is arranged so that some priority signals require different paths through the neural network then others to give the system a fast responding hierarchy to ensure the safe operation of the engine, system, and all of it components. If the inputting knock signal is too high, coolant temperature sensor voltage becomes too high, or the oxygen sensor reports extremely lean, as determined by the set bias voltages of each individual neural comparator, the control module will automatically, increase injection amount to the highest setting, and will remain there until the condition is over. As other conditions are reached or some go away, the system adjusts its plan of attack, automatically, accordingly to the output of its neural network. If the solution fluid level becomes too low, or the tank or line pressure somewhere is extremely low, signaling a leak, then the system will stop trying to inject solution and return the engine to run on the original fuel map, so that the disabled system will not cause the engine to run lean and knock. Over-boost protection, and intake temperature cut-offs can be added with the use of a pressure sensor module and temperature sensor module that input through their added individual neural comparator. All of the sensors that input on the regular input bus are used in the actual calculation of injection rate and timing. Other signals and voltages may also be used, such as manifold pressure, barometric pressure, intake air temp, exhaust gas temp, etc; however the major input relationships are described further in FIG. 3, FIG. 4 and FIG. 5. These signals form the regular input bus are inputted into the main calculation processor 2. This calculation processor 2 uses assembly code to determine the correct output responses, by using calculations schemes described in FIG. 3, FIG. 4, and FIG. 5. Once the calculation processor 2 has determined the correct output, it passes this information to the output processor 3. This output processor 3 is dedicated to controlling all of the outputs of the system. It sends out a manipulated airflow signal and oxygen sensor voltage to change original fuel system operating parameters. It also sends out control signals to the feed-back solenoid, the injector solenoid, and the pressure relief solenoid when it is determined by the calculation processor 3 that action is required.

FIG. 3 is a “Fuzzy” logic graph that outlines how the control module uses the oxygen sensor input voltage in its calculation of hydrogen peroxide flow rate changes. The graph shows that as the oxygen sensor voltage comes closer to 0 Volts, or severely lean, it progressively increases the amount of solution injected to give more of a supplement for the increasing lean situation. The graph also shows that as the oxygen sensor voltage becomes closer to 1 Volt, or extremely rich it progressively decreases the flow rate determined by the injector solenoid.

FIG. 4 is a “Fuzzy” logic graph that outlines how the control module uses airflow frequency, engine speed, and throttle position voltage in its calculation of hydrogen peroxide flow rate changes. The graph shows that as theses variables increase a progressively increased amount of solution is injected into the engine. The graph also shows that as these variables decrease a progressively decreased rate of peroxide solution is injected.

FIG. 5 is a “Fuzzy” logic graph that outlines how the control module uses hydrogen peroxide solution concentration and peroxide tank pressures in its calculation of hydrogen peroxide flow rate changes. The graph shows that as theses variables increase a progressively decreased amount of solution is injected into the engine. The graph also shows that as these variables decrease a progressively increased rate of peroxide solution is injected.

FIG. 6 is a diagram that shows a cutout view of an injector nozzle designed to deliver only hydrogen peroxide solution components to the intake of the engine's combustion chamber. This nozzle design is very straight-forward, except for the catalyst tube used as an isolator through the injector nozzle's throat. Partially decomposed solution enters from point 1. Once the solution enters this tube it comes in contact the catalyst section of the tube 2, which is made from one of many well know catalyst to hydrogen peroxide. At this point any peroxide remaining in the solution is decomposed to get the full benefits from the extra velocity created by the decomposition. Once the solution exits the catalyst section it is ejected through the exit of the isolation tube 3. The solution is then deflected by the edge of the injector and expelled into the intake manifold 4.

FIG. 7 is a diagram that shows a cutout view of an injector nozzle designed to deliver hydrogen peroxide solution components mixed with an external fuel source, like the factory fuel system, and eject the mix into the intake of the engine's combustion chamber. With this nozzle, hydrogen peroxide solution enters through the side at point 1. The external fuel supply enter into the top of the injector at point 2, so that it can stay in the isolator tube and mix thoroughly once it gets to point 4. The holes in this portion of the isolator tube are used to thoroughly premix the external fuel with the pressurized solution components. Partially decomposed solution enters from point 1. Once the solution enters this tube it comes in contact the catalyst section of the tube 3, which is made from one of many well know catalyst to hydrogen peroxide. At this point any peroxide remaining in the solution is decomposed to get the full benefits from the extra velocity created by the decomposition. Once the solution exits the isolator tube it is ejected through the exit of the isolation tube, deflected by the edge of the injector and expelled into the intake manifold 5. It must also be noted that most cases hydrogen peroxide left in the solution entering the intake manifold will decompose quickly upon impact with the hot intake manifold gases, and will be completely decomposed before it actually reaches the combustion chamber.

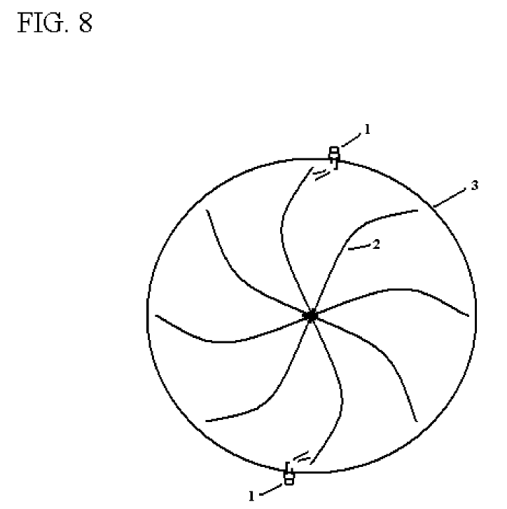

FIG. 8 shows a simplified view of how this hydrogen peroxide injection system could be used as direct power for a turbine driven motor designed to work with compressed gas. First it is important to note that for the best results a balance should be maintained when using the system this way. The diagram shows that there are two injector nozzles 1. The system should use pairs of injectors when used like this so that balance is maintained in the amount of force applied to the rotor or turbine assembly 2. Care must also be taken when arranging the clearance of the rotor 2, the injectors 1, and the turbine housing 3 it must also be noted that controls for a system like this is much more simple because the amount of solution injected is determined by only a throttle position sensor, since the speed at which the turbine spins will only be a factor of the amount of power required and is directly related to the amount of solution injected.

What is claimed is:

1. A system that will pressurize and inject low-concentration hydrogen peroxide/water/alcohol solutions within an existing fossil fuel engine to allow better fuel efficiency as it causes the engine to run safely in lean conditions, which would be made safe by the solution injections.

2. The system in claim 1 that can also be adapted to inject high concentration hydrogen peroxide/water solution injections into turbine or cylinder to use as a direct mechanism for generating power in many common engines designed to convert compressed gas into motion like, compressed air motors, linear air cylinders, etc.

3. The system in claim 1 wherein includes a self-pressurizing peroxide tank made of high concentration aluminum or stainless steel which is designed to contain pressurized hydrogen peroxide-based solution for injection into an engine.

4. The system in claim 1 wherein includes a hydrogen peroxide feedback catalyst which relies of the force due to gravity to pull hydrogen peroxide-based solutions through an opened feed-back solenoid leading from the bottom of the storage tank; and consists of any numerous mixtures of metal screens which is commonly known to cause rapidly accelerated, catalytic decomposition of hydrogen peroxide through the feedback loop which leads in to the top of the storage tank and pressurizes the hydrogen peroxide tank with expelled water and oxygen gas to use for pressurizing the hydrogen peroxide supply within the tank and used to inject the decomposed products of the reaction, water and oxygen, into an engine.

5. The system in claim 1 wherein includes a control computer which utilizes several microprocessors imbedded with progressive, calculus derivative-based, fuzzy logic style programming and neural network configured comparators supporting circuit to determine and control the operation conditions of the system in many situation including flagged or emergency operating conditions, for instance, when knock or pre-detonation is detected or when it is calculated that the engine is reaching its load capacity.

6. The system in claim 1 wherein includes a display module which is used to display graphical representations of a wide variety of many user selectable engine sensor parameters, hydrogen peroxide injection system parameters, and calculated values such as engine fuel consumption rate, percent fuel saved and engine load via standard RCA composite video synchronization or serial graphical LCD. The display module also has the ability to generate inverted graphical display data to the composite RCA output for use as a Heads-Up Display (HUD) projection setup using standard RCA composite video monitors.

7. The system in claim 1 wherein includes a user interface subsystem module that is equipped with two USB ports and one PS2 port to allow a user to communicate with the system with a PS2 keyboard, a USB mouse or other pointer device, and other upgradeable USB peripherals.

8. The system in claim 1 wherein includes a network of sensor monitoring microprocessor controlled subsystem input modules which can communicate with each other and the control computer via the system's data bus and can transmit recognizable control module data to represent hydrogen peroxide fuel amount, tank concentration information through a infrared fiber optic grating scan, tank pressure level, line pressure levels at several points to determine leaks, and can transmit engine conditions (including airflow signal, oxygen sensor voltages, intake air pressure voltages, intake air temperature voltages, barometric pressure voltages and knock or pre-detonation signals).

9. The system in claim 1 wherein includes a network of microprocessor controlled subsystem output modules that can generate outputs to corresponding solenoids, generate data signals to output to external sources, and generate external analog signals which can communicate with the control computer and each other via the system data bus. The solenoids are used to regulate the self-pressurizing peroxide tank mix feedback loop, control injection amount, and control injected solution concentration. The output subsystems can be used to regulate the amount hydrogen peroxide-based solution injection with received control computer calculations of tank and engine specifications. Output modules can also generated emulated MAS and MAF data signals to manipulate external sources, generate emulated analog oxygen sensor voltages to manipulate external sources, generate an emulated Throttle Position Sensor (TPS) voltage, generate various temperature senor voltages, and controls other vehicle features when manipulating existing engine (Electronic Control Module) ECM signals.

10. The system in claim 1 wherein includes one or more hydrogen peroxide-based solution injector nozzles, made of high concentration aluminum or stainless steel on critical parts, which are resistant to hydrogen peroxide corrosion, and include in some cases, catalytic materials on the catalytic portion of the nozzles isolator tube, that injects high concentration peroxide solution directly into a purely hydrogen peroxide decomposition pressure engine with a decomposition into water and oxygen being responsible for movement, or injects high concentration hydrogen peroxide in turbine jet or ram jet applications that rapidly decomposes the hydrogen peroxide into water and oxygen with the pressure and heat of the intake air creating higher pressures exhaust gas velocity to the turbine, or injects low concentration hydrogen peroxide into the intake of an existing combustion engine to lower intake temperatures, increase intake air velocity, introduce more oxygen and allow the vehicle's ECM to be manipulated to run in the leaner, lowered fuel, safe combustion region of operation.
